(19) United States
(12) Patent Application Publication
(10) Pub. No.: US 2025/0199365 A1
(43) Pub. Date: Jun. 19, 2025

(54) DISPLAY PANEL

(71) Applicant: AUO Corporation, Hsinchu City (TW)

(72) Inventors: Che-Min Lin, Hsinchu City (TW); Chun-Ru Huang, Hsinchu City (TW); Chu-Kuan Yu, Hsinchu City (TW); Kai-Teng Chiang, Hsinchu City (TW); FangMing Tsao, Hsinchu City (TW); Chen-Yu Wu, Hsinchu City (TW)

(73) Assignee: AUO Corporation, Hsinchu City (TW)

(21) Appl. No.: 18/976,293

(22) Filed: Dec. 10, 2024

(30) Foreign Application Priority Data
Dec. 19, 2023 (TW) 112149502

(51) Int. Cl. G02F 1/1339; G02F 1/1335; G02F 1/1362

(52) U.S. Cl. CPC G02F 1/1339; G02F 1/133514; G02F 1/136209; G02F 1/136286

(57) ABSTRACT

A display panel including a first substrate, a second substrate, a first protruding structure, a second protruding structure, and a light-shielding pattern layer is provided. The first protruding structure is disposed on the first substrate. The second protruding structure is disposed on the second substrate, and is adapted to abut against the first protruding structure. A width of the first protruding structure along a first direction is less than a width of the second protruding structure along the first direction. A width of the first protruding structure along a second direction is greater than a width of the second protruding structure along the second direction. An orthogonal projection of the first protruding structure on the first substrate is located within an orthogonal projection of a first light-shielding pattern on the first substrate. The first protruding structure and the first light-shielding pattern respectively have a structural edge and a pattern edge adjacent to each other along the first direction or the second direction. A spacing between the structural edge and the pattern edge along the first direction or the second direction is equal to 5 micrometers.

### CROSS-REFERENCE TO RELATED APPLICATION

This application claims the priority benefit of Taiwan application serial no. 112149502, filed on Dec. 19, 2023. The entirety of the above-mentioned patent application is hereby incorporated by reference herein and made a part of this specification.

### BACKGROUND

### Technical Field

The disclosure relates to a display technology, and particularly relates to a display panel.

### Description of Related Art

Current liquid crystal display panels require the use of alignment films to align the liquid crystal layer, and a plurality of spacers provided between two substrates are utilized to control the thickness of the liquid crystal layer. When the liquid crystal display panel is subjected to external force, the displacement of these spacers will scratch the alignment layer on the opposite substrate, causing light leakage in the dark state of the liquid crystal display panel. In order to solve this problem, a method of using a light-shielding pattern layer to block scratches on the alignment layer has been proposed. However, if the maximum possible displacement of the spacer is taken into consideration, such an approach will lead to a decrease in the opening ratio of the liquid crystal display panel.

### SUMMARY

The disclosure provides a display panel that has both a better opening ratio and external force tolerance.

A display panel of the disclosure includes a first substrate, a second substrate, a first protruding structure, and a second protruding structure. The first substrate and the second substrate are disposed opposite to each other. The first protruding structure is disposed on the first substrate. The second protruding structure is disposed on the second substrate, and is adapted to abut against the first protruding structure. A first width of the first protruding structure along a first direction is less than a second width of the second protruding structure along the first direction. A third width of the first protruding structure along a second direction is greater than a fourth width of the second protruding structure along the second direction. The first direction intersects with the second direction. A spacing between the first protruding structure and the second protruding structure along a stacking direction of the first substrate and the second substrate is greater than or equal to 0.5 micrometer and less than or equal to 0.7 micrometer.

A display panel of the disclosure includes a first substrate, a second substrate, a first protruding structure, a second protruding structure, and a light-shielding pattern layer. The first substrate and the second substrate are disposed opposite to each other. The first protruding structure is disposed on the first substrate. The second protruding structure is disposed on the second substrate, and is adapted to abut against the first protruding structure. A first width of the first protruding structure along a first direction is less than a second width of the second protruding structure along the first direction. A third width of the first protruding structure along a second direction is greater than a fourth width of the second protruding structure along the second direction. The first direction intersects with the second direction. The light-shielding pattern layer has a first light-shielding pattern overlapped with the first protruding structure. An orthogonal projection of the first protruding structure on the first substrate is located within an orthogonal projection of the first light-shielding pattern on the first substrate. The first protruding structure and the first light-shielding pattern respectively have a structural edge and a pattern edge adjacent to each other along the first direction or the second direction, and a spacing between the structural edge and the pattern edge along the first direction or the second direction is equal to 5 micrometers.

Based on the above, in the display panel according to an embodiment of the disclosure, the first protruding structure and the second protruding structure that are overlapped with each other and adapted to abut against each other are respectively provided on the two substrates. The first protruding structure is completely overlapped with the light-shielding pattern of the light-shielding pattern layer. Since the extending direction of the first protruding structure intersects with the extending direction of the second protruding structure, it is only necessary to extend the light-shielding pattern outward by 5 micrometers in any direction relative to the first protruding structure to prevent dark state light leakage caused by the scratching of the film layer on the first substrate by the second protruding structure. Accordingly, the opening ratio of the display panel may be effectively improved.

### BRIEF DESCRIPTION OF THE DRAWINGS

FIG. 1 is a schematic front view of a display panel according to a first embodiment of the disclosure.

FIG. 2 is an enlarged schematic view of a partial region of the display panel depicted in FIG. 1.

FIG. 3A and FIG. 3B are schematic cross-sectional views of the display panel depicted in FIG. 1.

FIG. 4 is a schematic cross-sectional view of the display panel of another modified embodiment depicted in FIG. 3A.

FIG. 5 is a schematic front view of a display panel according to a second embodiment of the disclosure.

FIG. 6 is an enlarged schematic view of a partial region of the display panel depicted in FIG. 5.

### DESCRIPTION OF THE EMBODIMENTS

The term “about,” “approximately,” “essentially,” or “substantially” as used herein is inclusive of the stated value and means within an acceptable range of deviation for the particular value as determined by people having ordinary skill in the art, considering the measurement in question and the error associated with the measurement of the particular quantity (i.e., the limitations of the measurement system). For example, “about” may mean within one or more standard deviations, for example, within ±30%, ±20%, ±15%, ±10%, ±5% of the stated value. Furthermore, a relatively acceptable range of deviation or standard deviation may be chosen for the terms “about,” “approximately,” “essentially,” or “substantially” as used herein based on measuring properties, cutting properties or other properties, instead of applying one standard deviation across all the properties.

In the drawings, the thicknesses of layers, films, panels, regions, etc., are exaggerated for clarity. It should be understood that when an element such as a layer, film, region, or substrate is referred to as being “on” or “connected to” another element, it may be directly on or connected to another element, or intervening elements may also be present. In contrast, when an element is referred to as being “directly on” or “directly connected to” another element, no intervening elements are present. As used herein, “connected” may refer to physical connection and/or electrical connection. Furthermore, “electrical connection” may mean the presence of other elements between two elements.

Moreover, relative terms such as “under” or “bottom” and “above” or “top” may be used for describing a relationship of one element and another element as that shown in figures. It should be noted that the relative terms are intended to include a different orientation of the device besides the orientation shown in the figure. For example, if a device in a figure is flipped over, the element originally described to be located “under” other element is oriented to be located “above” the other element. Therefore, the illustrative term “under” may include orientations of “under” and “on”, which is determined by the specific orientation of the figure. Similarly, if a device in a figure is flipped over, the element originally described to be located “below” or “underneath” other element is oriented to be located “on” the other element. Therefore, the illustrative term “under” or “below” may include orientations of “above” and “under”.

The exemplary embodiment is described below with reference of a cross-sectional view of a schematic diagram of an idealized embodiment. Therefore, a shape change of the figure serving as a result of manufacturing techniques and/or tolerances may be expected. Therefore, the embodiment of the disclosure should not be construed as limited to a particular shape of a region as shown herein, but includes a shape deviation caused by manufacturing tolerance. For example, a shown or described flat area may generally have rough and/or non-linear features. Moreover, a shown acute angle may be round. Therefore, a region shown in the figure is essentially schematic, and a shape thereof is not intended to show an accurate shape of the region, and is not intended to limit a range of the claims of the disclosure.

Reference will now be made in detail to the present preferred embodiments of the disclosure, examples of which are illustrated in the accompanying drawings. Whenever possible, the same reference numbers are used in the drawings and description to refer to the same or like parts.

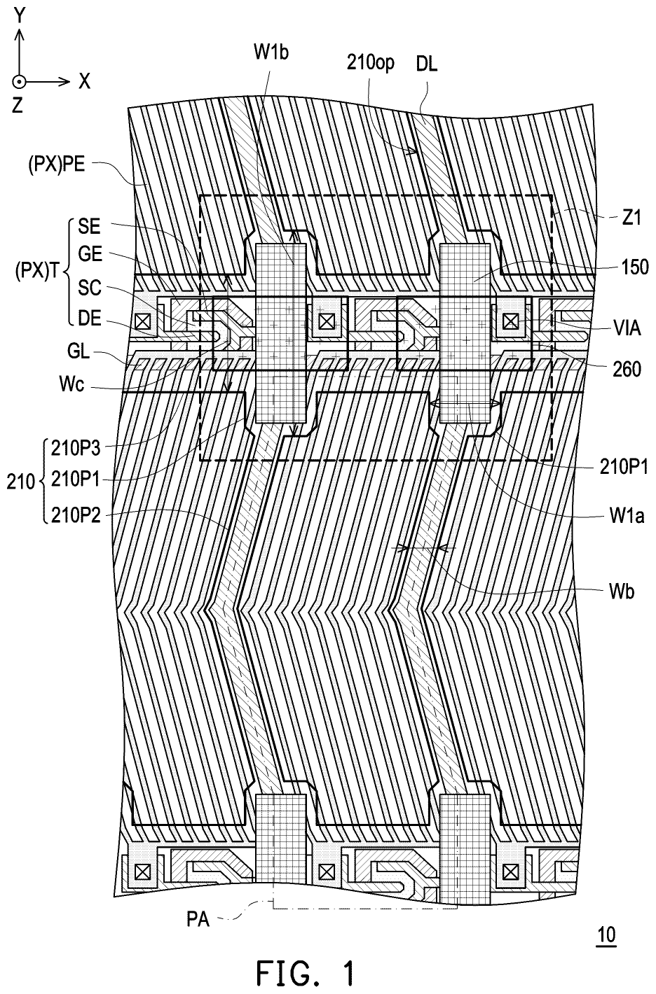

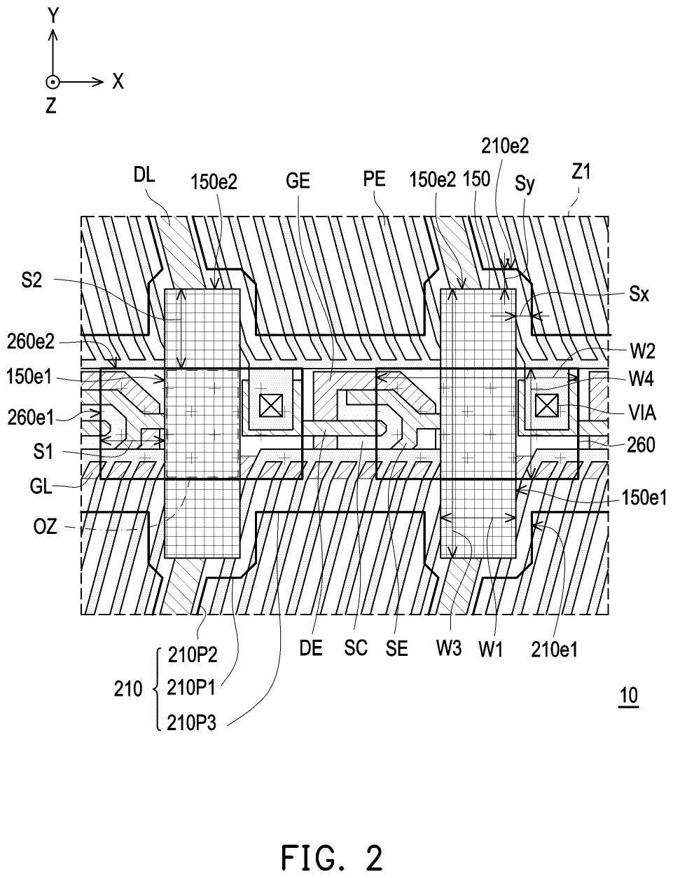

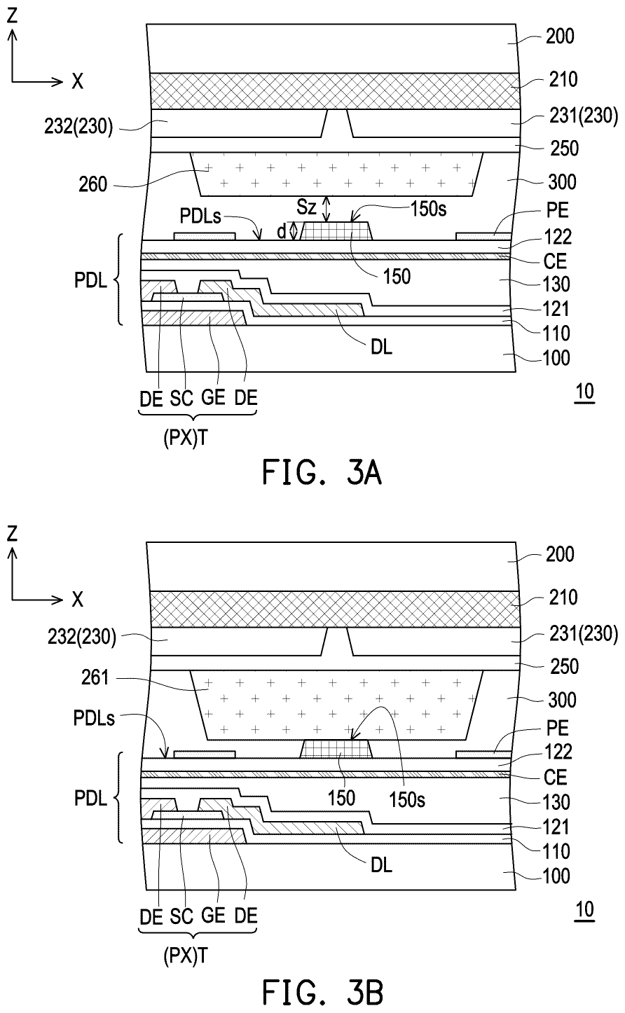

FIG. 1 is a schematic front view of a display panel according to a first embodiment of the disclosure. FIG. 2 is an enlarged schematic view of a partial region Z1 of the display panel depicted in FIG. 1. FIG. 3A and FIG. 3B are schematic cross-sectional views of the display panel depicted in FIG. 1.

Referring to FIG. 1, FIG. 2, and FIG. 3A, a display panel 10 includes a first substrate 100, a second substrate 200, a plurality of first protruding structures 150, and a plurality of second protruding structures 260. The first substrate 100 and the second substrate 200 are disposed opposite to each other. The first protruding structures 150 are disposed on the first substrate 100. The second protruding structures 260 are disposed on the second substrate 200. The first protruding structures 150 and the second protruding structures 260 are respectively overlapped with each other along a stacking direction (for example, a direction Z) of the first substrate 100 and the second substrate 200 and are adapted to abut against each other.

It is particularly noted that an extending direction of the first protruding structure 150 (for example, a direction Y) intersects with an extending direction of the second protruding structure 260 (for example, a direction X). For example, in the embodiment, a first width W1 of the first protruding structure 150 along a first direction (for example, the direction X) is less than a second width W2 of the second protruding structure 260 along the first direction, a third width W3 of the first protruding structure 150 along a second direction (for example, the direction Y) is greater than a fourth width W4 of the second protruding structure 260 along the second direction. The direction X and the direction Y may be selectively perpendicular to each other, but the disclosure is not limited thereto. More specifically, a profile of an orthogonal projection of the first protruding structure 150 and the second protruding structure 260 overlapped with each other on the first substrate 100 substantially forms a cross shape.

However, the disclosure is not limited thereto. In other embodiments not shown, the extending direction of the first protruding structure may be parallel to an extending direction of a scan line GL (for example, the direction X), and the extending direction of the second protruding structure may be parallel to an extending direction of a data line DL (for example, the direction Y).

In the embodiment, a pixel driving layer PDL may be disposed on the first substrate 100. The pixel driving layer PDL includes, for example, a plurality of data lines DL, a plurality of scan lines GL, and a plurality of pixel structures PX. For example, the plurality of data lines DL may be arranged at intervals along the direction X and extend in the direction Y, and the plurality of scan lines GL may be arranged at intervals along the direction Y and extend in the direction X. The data lines DL intersect with the scan lines GL and define a plurality of pixel regions PA. The plurality of pixel structures PX are respectively disposed in the pixel regions PA.

The pixel structure PX may include an active component T and a pixel electrode PE that are electrically connected to each other. In the embodiment, the method of forming the active component T may include the following steps: sequentially forming a gate GE, a gate insulating layer 110, a semiconductor pattern SC, a source SE, and a drain DE on the first substrate 100, where the source SE and the drain DE are in direct contact with two different regions of the semiconductor pattern SC (for example, the source region and the drain region).

In the embodiment, the gate GE of the active component T may be selectively disposed under the semiconductor pattern SC to form a bottom-gate TFT, but the disclosure is not limited thereto. According to other embodiments, the gate GE of the active component may also be disposed above the semiconductor pattern SC to form a top-gate TFT. On the other hand, a material of the semiconductor pattern SC is, for example, amorphous silicon material. That is to say, the active component T may be an amorphous silicon (a-Si) TFT. However, the disclosure is not limited thereto. In other embodiments, the active component may also be a low-temperature-poly-silicon (LTPS) TFT, a microcrystalline silicon (micro-Si) TFT, or a metal oxide transistor.

After the active component T is completed, a passivation layer 121, a planarization layer 130, a passivation layer 122, and the pixel electrode PE are sequentially formed on the source SE and the drain DE. In the embodiment, a common electrode layer CE may also be formed between the passivation layer 122 and the planarization layer 130, and the pixel electrode PE may have a plurality of slits overlapped with the common electrode layer CE along the direction Z, but the disclosure is not limited thereto. The pixel electrode PE may be electrically connected to the drain DE of the active component T through a contact hole VIA (shown in FIG. 2) formed by the passivation layer 122, the planarization layer 130, and the passivation layer 121.

On the other hand, in the embodiment, a light-shielding pattern layer 210, a color filter layer 230, and a covering layer 250 may be sequentially disposed on the second substrate 200. The light-shielding pattern layer 210 has a plurality of openings 210op, and the openings 210op are respectively overlapped with the aforementioned plurality of pixel regions PA. More specifically, the light-shielding pattern layer 210 is overlapped with the plurality of scan lines GL and the plurality of data lines DL along the direction Z. The color filter layer 230 may include a plurality of color filter patterns (for example, a color filter pattern 231 and a color filter pattern 232 that allow light of different colors to pass through). The color filter patterns are respectively disposed corresponding to the plurality of openings 210op of the light-shielding pattern layer 210, and extend to the light-shielding pattern layer 210. The color filter layer 230 may be covered with a covering layer 250.

That is to say, in the embodiment, the first substrate 100 and the pixel driving layer PDL thereon may constitute the pixel array substrate of the display panel 10, and the second substrate 200 and the plurality of film layers thereon may constitute the color filter substrate of the display panel 10.

It should be noted that, the gate GE, the source SE, the drain DE, the gate insulating layer 110, the passivation layer 121, the passivation layer 122, the planarization layer 130, the common electrode layer CE, the pixel electrode PE, the light-shielding pattern layer 210, the color filter layer 230, and the covering layer 250 may be respectively implemented by any gate, any source, any drain, any gate insulating layer, any passivation layer, any planarization layer, any common electrode layer, any pixel electrode, any light-shielding pattern layer, any color filter layer, and any covering layer well known to those skilled in the art for use in display panels, and the gate GE, the source SE, the drain DE, the gate insulating layer 110, the passivation layer 121, the passivation layer 122, the planarization layer 130, the common electrode layer CE, the pixel electrode PE, the light-shielding pattern layer 210, the color filter layer 230, and the covering layer 250 may be respectively formed by any method well known to those skilled in the art, and therefore detailed descriptions thereof are omitted herein.

It should be noted that a liquid crystal layer 300 may be sandwiched between the aforementioned pixel array substrate and the color filter substrate (that is, between the first substrate 100 and the second substrate 200). In order to stably maintain the thickness of the liquid crystal layer 300, a plurality of spacers are required between the two substrates of the display panel 10. The spacers may be divided into primary spacers and secondary spacers, for example. When the display panel 10 is in a natural state (that is, without external force), the primary spacer contacts the pixel array substrate and the color filter substrate at the same time, but the secondary spacer does not contact the pixel array substrate and the color filter substrate at the same time.

For example, in the embodiment, the plurality of first protruding structures 150 may be disposed on a surface PDLs (for example, a surface of the passivation layer 122) of the pixel driving layer PDL, and the plurality of second protruding structures 260 may be disposed on a surface of the covering layer 250, but the disclosure is not limited thereto. It is particularly noted that in the embodiment, the second protruding structure 260 may serve as a secondary spacer of the display panel 10. That is, when the display panel 10 is in a natural state, the second protruding structure 260 does not contact the pixel array substrate (as shown in FIG. 3A). More specifically, the first protruding structure 150 and the second protruding structure 260 have a spacing Sz along the direction Z, and the spacing Sz is greater than or equal to 0.5 micrometers and less than or equal to 0.7 micrometers.

On the other hand, a plurality of second protruding structures 261 may also be disposed on the second substrate 200, and the first protruding structure 150 may also be disposed on the pixel array substrate at a position overlapped with each second protruding structure 261. When the display panel 10 is in a natural state, the second protruding structure 261 contacts the first protruding structure 150 on the pixel array substrate (as shown in FIG. 3B). That is, in the embodiment, the second protruding structure 261 may serve as the primary spacer of the display panel 10.

Referring to FIG. 1 and FIG. 2, in the embodiment, the light-shielding pattern layer 210 has a light-shielding pattern 210P1 that is overlapped with the first protruding structure 150 along the direction Z. It is particularly noted that an orthogonal projection of the first protruding structure 150 on the first substrate 100 is located within an orthogonal projection of the light-shielding pattern 210P1 on the first substrate 100. In the embodiment, the first protruding structure 150 and the light-shielding pattern 210P1 have a structural edge 150e1 and a pattern edge 210e1 adjacent to each other along the direction X and have a structural edge 150e2 and a pattern edge 210e2 adjacent to each other along the direction Y. A spacing Sx between the structural edge 150e1 and the pattern edge 210e1 along the direction X and/or a spacing Sy between the structural edge 150e2 and the pattern edge 210e2 along the direction Y is equal to 5 micrometers.

It should be understood that in order to orient the liquid crystal layer 300, the display panel 10 may be provided with two alignment layers (not shown) on the pixel array substrate and the color filter substrate respectively, and the two alignment layers cover the two surfaces of the first protruding structure 150 and the second protruding structure 260 facing each other. When the display panel is subjected to external force (that is, unnatural state), the spacer is squeezed by the two substrates and displaced. As a result, the alignment film on the opposite substrate opposite to the spacer (for example, the pixel array substrate of the embodiment) is easily scratched by the moving spacer, causing light leakage when the display panel is operated in a dark state.

Through the arrangement of the first protruding structure 150, even if the display panel 10 is subjected to an external force and the second protruding structure 260 is pressed against the opposite substrate and moves and scratches the alignment film thereon, only the portion of the alignment film that is overlapped with the first protruding structure may be damaged. Therefore, the light-shielding pattern 210P1 only needs to extend 5 micrometers outward relative to the first protruding structure 150 to block the light leakage generated by the damaged alignment film in the dark state. In other words, through the aforementioned configuration relationship between the first protruding structure 150 and the second protruding structure 260, the opening ratio of the display panel 10 may be greatly improved while solving the light leakage problem.

Referring to FIG. 3A and FIG. 3B, it is particularly noted that the first protruding structure 150 overlapped with the second protruding structure 261 serving as the primary spacer and its overlapping light-shielding pattern may also be arranged in the aforementioned manner to obtain the same technical effects. In order to allow the configuration relationship between the first protruding structure 150 and the second protruding structure 260 to be applied to the second protruding structure 261 serving as the primary spacer and its overlapping first protruding structure 150, and to ensure that the same technical effect may be obtained, a distance d between a structural surface 150s of the first protruding structure 150 away from the pixel driving layer PDL and the surface PDLs of the pixel driving layer PDL along the direction Z (that is, the stacking direction) should be greater than or equal to 0.5 micrometers and less than or equal to 0.7 micrometers.

In the embodiment, the first protruding structure 150 may be made of a metal layer different from the gate GE, source SE, and drain DE, but the disclosure is not limited thereto. In other embodiments, the first protruding structure may also be formed by using an organic insulating layer or a plurality of metal layers (for example, a first metal layer forming the gate GE and a second metal layer forming the source SE and the drain DE).

Referring to FIG. 1, FIG. 2, and FIG. 3A, furthermore, the plurality of first protruding structures 150 and the plurality of second protruding structures 260 may be provided in the plurality of pixel regions PA of the display panel 10. If a percentage value of an overlapping area of the first protruding structures 150 and the second protruding structures 260 along the direction Z (for example, an area of an overlapping region OZ in FIG. 2) with respect to an orthogonal projection area of the pixel regions PA on the first substrate 100 is greater than or equal to 1% and less than or equal to 2%, the reduction in the width of the first protruding structure 150 along the direction X may produce a more significant improvement in the opening ratio of the display panel 10.

On the other hand, the first protruding structure 150 and the second protruding structure 260 respectively have the adjacent structural edge 150e1 and structural edge 260e1 along the direction X, and respectively have the adjacent structural edge 150e2 and structural edge 260e2 along the direction Y. Preferably, a spacing S1 between the structural edge 150e1 and the structural edge 260e1 along the direction X may be greater than or equal to 5 micrometers and less than or equal to 16 micrometers, a spacing S2 between the structural edge 150e2 and the structural edge 260e2 along the direction Y may be greater than or equal to 5 micrometers and less than or equal to 23 micrometers. The aforementioned design relationship also applies to the first protruding structure 150 and the second protruding structure 261.

Accordingly, when the display panel 10 is in an unnatural state (that is, subjected to external force), the abutting relationship between the first protruding structure 150 and the second protruding structure 260 overlapped with each other may be ensured. That is to say, through the above configuration relationship, when the first protruding structure 150 is configured to abut against the second protruding structure 260, the relative displacement between each other will not cause the second protruding structure 260 to sink from the structural surface 150s of the first protruding structure 150 to the surface PDLs of the pixel driving layer PDL, thereby avoiding damage to other portions of the alignment layer on the pixel array substrate.

Furthermore, in the embodiment, any group of first protruding structures 150 and second protruding structures 260 overlapped with each other may be disposed at the boundary of four pixel regions PA. More specifically, the first protruding structure 150 and the second protruding structure 260 may be overlapped along the direction Z at the intersection of the data line DL and the scan line GL. Therefore, the light-shielding pattern 210P1 used to block the first protruding structure 150 is also overlapped at the intersection of the data line DL and the scan line GL.

In addition, the light-shielding pattern layer 210 may also have a light-shielding pattern 210P2 and a light-shielding pattern 210P3 connected to the light-shielding pattern 210P1. The light-shielding pattern 210P2 is overlapped with the data line DL along the direction Z but not overlapped with the scan line GL and the first protruding structure 150. The light-shielding pattern 210P3 is overlapped with the scan line GL along the direction Z but not overlapped with the data line DL and the first protruding structure 150.

Of particular note is that since the light-shielding pattern 210P1 needs to extend 5 micrometers outward relative to the first protruding structure 150 to block the light leakage generated by the alignment film damaged by the second protruding structure 260 in the dark state, a width W1a of the light-shielding pattern 210P1 along the direction X is greater than a width Wb of the light-shielding pattern 210P2 along the direction X, and a width W1b of the light-shielding pattern 210P1 along the direction Y is greater than a width Wc of the light-shielding pattern 210P3 along the direction Y. That is to say, in the embodiment, the four sides of the light-shielding pattern 210P1 connecting the two light-shielding patterns 210P2 and the two light-shielding patterns 210P3 form four corner portions extending outwardly relative to the light-shielding pattern 210P2 and the light-shielding pattern 210P3.

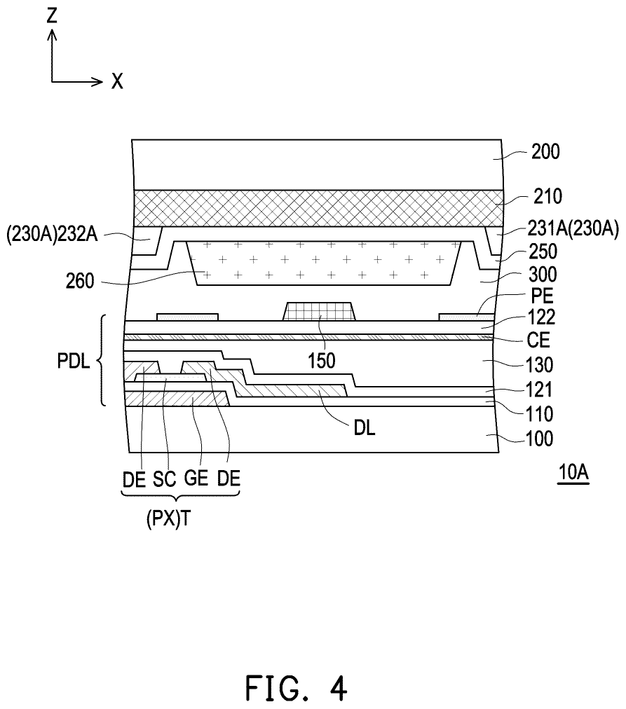

FIG. 4 is a schematic cross-sectional view of the display panel of another modified embodiment depicted in FIG. 3A. Referring to FIG. 4, the difference between a display panel 10A of the embodiment and the display panel 10 depicted in FIG. 3A is that the configuration relationship between the second protruding structure and the color filter layer is different. Specifically, in the embodiment, an orthogonal projection of the second protruding structure 260 on the second substrate 200 is not overlapped with an orthogonal projection of a color filter layer 230A on the second substrate 200.

That is to say, in the embodiment, the interval distance between the plurality of color filter patterns of the color filter layer 230A (for example, a color filter pattern 231A and a color filter pattern 232A that allow light of different colors to pass through) is significantly greater compared to the color filter layer 230 depicted in FIG. 3A, so as to form a plurality of micro-grooves sufficient to accommodate the plurality of second protruding structures 260. Through the arrangement of these micro-grooves, the thickness design margin of the second protruding structure 260 in the direction Z may be increased to meet the application requirements of display panels with different film thicknesses of the liquid crystal layer 300.

In the following, other embodiments are provided to explain the disclosure in detail. The same members are labeled with the same reference numerals, and the description of the same technical content is omitted. For the omitted parts, please refer to the above embodiment, which is not repeated herein.

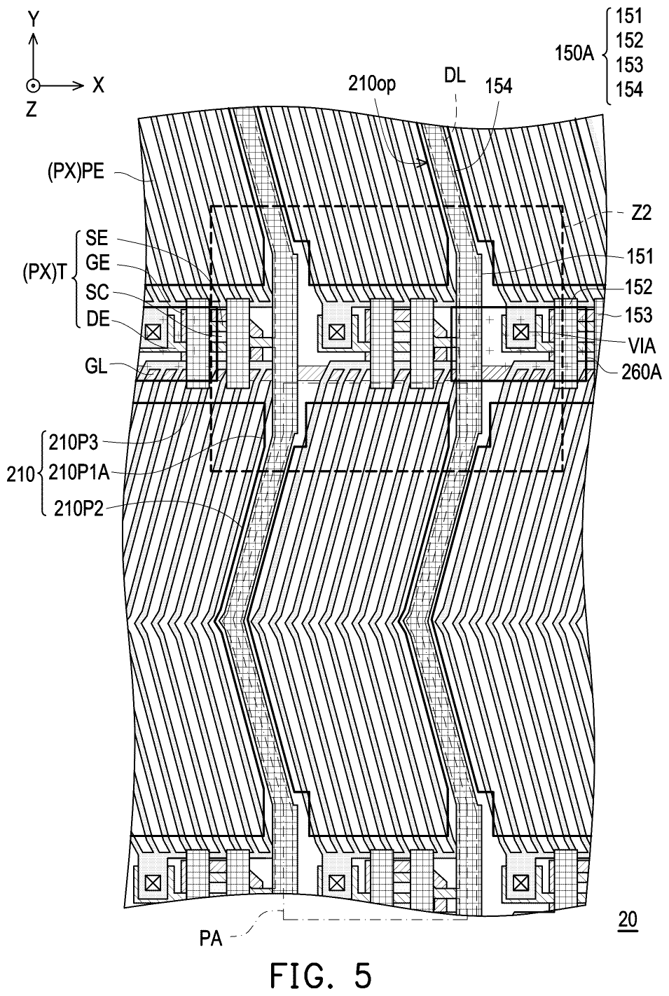

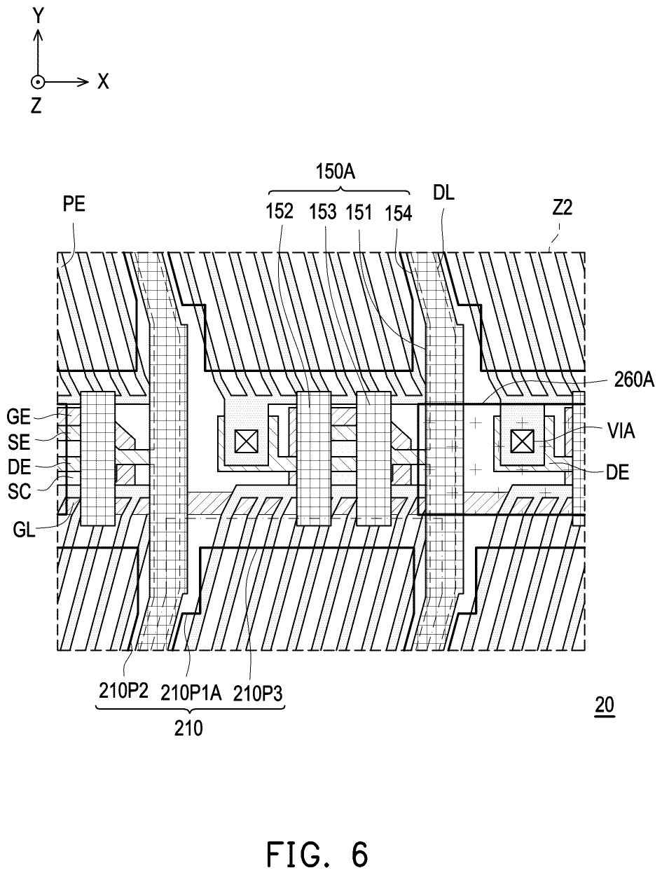

FIG. 5 is a schematic front view of a display panel according to a second embodiment of the disclosure. FIG. 6 is an enlarged schematic view of a partial region Z2 of the display panel depicted in FIG. 5. Referring to FIG. 5 and FIG. 6, the difference between a display panel 20 of the embodiment and the display panel 10 depicted in FIG. 1 is that the design of the first protruding structure is different. Specifically, in the display panel 20 of the embodiment, the number of first protruding structures 150A overlapped with second protruding structure 260A along the direction Z may be plural. For example, the number of the first protruding structures 150A disposed corresponding to the second protruding structure 260A is three, which are a first protruding structure 151, a first protruding structure 152, and a first protruding 153 that are structurally separated from each other.

In the embodiment, the first protruding structure 151, the first protruding structure 152, and the first protruding structure 153 may be arranged at intervals along the direction X. When the display panel 20 is in an unnatural state, any two adjacent ones of the first protruding structure 151, the first protruding structure 152, and the first protruding structure 153 are adapted to abut against the second protruding structure 260A at the same time, but the disclosure is not limited thereto. In other embodiments, the number of the first protruding structures that abut against the second protruding structure at the same time may be adjusted according to different design requirements.

It is particularly noted that since the plurality of first protruding structures 150A are adapted to abut against the second protruding structure 260A at the same time, the width of each of these first protruding structures 150A along the direction X may be designed to be less than the width of the first protruding structure 150 depicted in FIG. 1 along the X direction. In particular, the first protruding structure 151, which is overlapped at the intersection of the data line DL and the scan line GL, has a reduced width compared to the first protruding structure 150 depicted in FIG. 1. Such a reduction in width enables a light-shielding pattern 210P1A of a light-shielding pattern layer 210A to retract inwardly on both edges in the direction X towards the data line DL, which serves to further enhance the opening ratio of the display panel 20.

On the other hand, in the embodiment, a plurality of first protruding structures 151 overlapped with the plurality of data lines DL and the plurality of scan lines GL along the direction Z may be connected in series through a plurality of first protruding structures 154. The first protruding structures 154 are overlapped with the plurality of data lines DL along the direction Z.

To sum up, in the display panel according to an embodiment of the disclosure, the first protruding structure and the second protruding structure that are overlapped each other and adapted to abut against each other are respectively provided on the two substrates. The first protruding structure is completely overlapped with the light-shielding pattern of the light-shielding pattern layer. Since the extending direction of the first protruding structure intersects with the extending direction of the second protruding structure, it is only necessary to extend the light-shielding pattern outward by 5 micrometers in any direction relative to the first protruding structure to prevent dark state light leakage caused by the scratching of the film layer on the first substrate by the second protruding structure. Accordingly, the opening ratio of the display panel may be effectively improved.

What is claimed is:

1. A display panel, comprising:
a first substrate;
a second substrate, disposed opposite to the first substrate;
a first protruding structure, disposed on the first substrate; and
a second protruding structure, disposed on the second substrate, and adapted to abut against the first protruding structure, wherein a first width of the first protruding structure along a first direction is less than a second width of the second protruding structure along the first direction, a third width of the first protruding structure along a second direction is greater than a fourth width of the second protruding structure along the second direction, the first direction intersects with the second direction, and a spacing between the first protruding structure and the second protruding structure along a stacking direction of the first substrate and the second substrate is greater than or equal to 0.5 micrometers and less than or equal to 0.7 micrometers.

2. The display panel according to claim 1, further comprising:
a light-shielding pattern, overlapped with the first protruding structure, wherein an orthogonal projection of the first protruding structure on the first substrate is located within an orthogonal projection of the light-shielding pattern on the first substrate, the first protruding structure and the light-shielding pattern respectively have a structural edge and a pattern edge adjacent to each other along the first direction or the second direction, and a spacing between the structural edge and the pattern edge along the first direction or the second direction is equal to 5 micrometers.

3. The display panel according to claim 1, wherein a pixel driving layer is disposed on the first substrate, the first protruding structure is disposed on a surface of the pixel driving layer, the first protruding structure has a structural surface away from the surface, and a distance between the structural surface and the surface of the pixel driving layer along the stacking direction is greater than or equal to 0.5 micrometers and less than or equal to 0.7 micrometers.

4. The display panel according to claim 1, further comprising:
a color filter layer, disposed on the second substrate, and located between the second protruding structure and the second substrate, wherein an orthogonal projection of the second protruding structure on the second substrate is not overlapped with an orthogonal projection of the color filter layer on the second substrate.

5. The display panel according to claim 1, further comprising:
another first protruding structure, disposed on the first substrate, wherein the first protruding structure and the another first protruding structure are arranged at intervals along the first direction and are adapted to abut against the second protruding structure at the same time.

6. The display panel according to claim 1, having a plurality of pixel regions, wherein a plurality of the first protruding structures and a plurality of the second protruding structures are disposed in the pixel regions, and a percentage value of an overlapping area of the first protruding structures and the second protruding structures along the stacking direction with respect to an orthogonal projection area of the pixel regions on the first substrate is greater than or equal to 1% and less than or equal to 2%.

7. The display panel according to claim 1, further comprising:
a plurality of data lines, disposed on the first substrate, and arranged at intervals along the first direction, wherein the first protruding structure and the second protruding structure respectively have a first structural edge and a second structural edge adjacent to each other along the first direction, a spacing between the first structural edge and the second structural edge along the first direction is greater than or equal to 5 micrometers and less than or equal to 16 micrometers, the first protruding structure and the second protruding structure respectively have an adjacent third structural edge and fourth structural edge along the second direction, and a spacing between the third structural edge and the fourth structural edge along the second direction is greater than or equal to 5 micrometers and less than or equal to 23 micrometers.

8. The display panel according to claim 1, further comprising:
a plurality of data lines, disposed on the first substrate, and arranged at intervals along the first direction;
a plurality of scan lines, disposed on the first substrate, and arranged at intervals along the second direction, wherein the first protruding structure and the second protruding structure are overlapped with one of the data lines and one of the scan lines; and
a light-shielding pattern layer, disposed on the second substrate, wherein the light-shielding pattern layer has a first light-shielding pattern, a second light-shielding pattern, and a third light-shielding pattern connected to each other, the first light-shielding pattern is overlapped with the first protruding structure, the second light-shielding pattern is overlapped with the one of the data lines but not overlapped with the one of the scan lines and the first protruding structure, the third light-shielding pattern is overlapped with the one of the scan lines but not overlapped with the one of the data lines and the first protruding structure,
a width of the first light-shielding pattern along the first direction is greater than a width of the second light-shielding pattern along the first direction, and a width of the first light-shielding pattern along the second direction is greater than a width of the third light-shielding pattern along the second direction.

9. A display panel, comprising:
a first substrate;
a second substrate, disposed opposite to the first substrate;
a first protruding structure, disposed on the first substrate;
a second protruding structure, disposed on the second substrate, and adapted to abut against the first protruding structure, wherein a first width of the first protruding structure along a first direction is less than a second width of the second protruding structure along the first direction, a third width of the first protruding structure along a second direction is greater than a fourth width of the second protruding structure along the second direction, and the first direction intersects with the second direction; and
a light-shielding pattern layer, having a first light-shielding pattern overlapped with the first protruding structure, wherein an orthogonal projection of the first protruding structure on the first substrate is located within an orthogonal projection of the first light-shielding pattern on the first substrate, the first protruding structure and the first light-shielding pattern respectively have a structural edge and a pattern edge adjacent to each other along the first direction or the second direction, and a spacing between the structural edge and the pattern edge along the first direction or the second direction is equal to 5 micrometers.

10. The display panel according to claim 9, further comprising:
a color filter layer, disposed on the second substrate, and located between the second protruding structure and the second substrate, wherein an orthogonal projection of the second protruding structure on the second substrate is not overlapped with an orthogonal projection of the color filter layer on the second substrate.

11. The display panel according to claim 9, further comprising:
another first protruding structure, disposed on the first substrate, wherein the first protruding structure and the another first protruding structure are arranged at intervals along the first direction and are adapted to abut against the second protruding structure at the same time.

12. The display panel according to claim 9, further comprising:
a plurality of data lines, disposed on the first substrate, and arranged at intervals along the first direction, wherein the first protruding structure and the second protruding structure respectively have a first structural edge and a second structural edge adjacent to each other along the first direction, a spacing between the first structural edge and the second structural edge along the first direction is greater than or equal to 5 micrometers and less than or equal to 16 micrometers, the first protruding structure and the second protruding structure respectively have a third structural edge and a fourth structural edge adjacent to each other along the second direction, and a spacing between the third structural edge and the fourth structural edge along the second direction is greater than or equal to 5 micrometers and less than or equal to 23 micrometers.

13. The display panel according to claim 9, further comprising:
a plurality of data lines, disposed on the first substrate, and arranged at intervals along the first direction; and
a plurality of scan lines, disposed on the first substrate, and arranged at intervals along the second direction, wherein the first protruding structure and the second protruding structure are overlapped with one of the data lines and one of the scan lines,
the light-shielding pattern layer further has a second light-shielding pattern and a third light-shielding pattern connected to the first light-shielding pattern, the second light-shielding pattern is overlapped with the one of the data lines but not overlapped with the one of the scan lines and the first protruding structure, the third light-shielding pattern is overlapped with the one of the scan lines but not overlapped with the one of the data lines and the first protruding structure, a width of the first light-shielding pattern along the first direction is greater than a width of the second light-shielding pattern along the first direction, and a width of the first light-shielding pattern along the second direction is greater than a width of the third light-shielding pattern along the second direction.

14. The display panel according to claim 9, wherein a spacing between the first protruding structure and the second protruding structure along a stacking direction of the first substrate and the second substrate is greater than or equal to 0.5 micrometers and less than or equal to 0.7 micrometers.
